(19) United States
(12) Patent Application Publication
(10) Pub. No.: US 2025/0148842 A1
(43) Pub. Date: May 8, 2025

(54) METHOD AND APPARATUS FOR DETECTING A HANDS-OFF STATE AT A STEERING WHEEL

(71) Applicant: Volkswagen Aktiengesellschaft, Wolfsburg (DE)

(72) Inventors: Jonas Kaste, Braunschweig (DE); Daniel Münning, Braunschweig (DE); Felix Stahl, Braunschweig (DE); Felix Kallmeyer, Wolfsburg (DE)

(21) Appl. No.: 18/941,532

(22) Filed: Nov. 8, 2024

(30) Foreign Application Priority Data
Nov. 8, 2023 (DE) 10 2023 211 071.7

(51) Int. Cl. G07C 5/02; G06N 20/00

(52) U.S. Cl. CPC G07C 5/02; G06N 20/00

(57) ABSTRACT

A method for detecting a hands-off state at a steering wheel. A steering variable is captured at the steering wheel and the captured steering variable is supplied as input data to at least two trained machine learning models. The machine learning models are trained to detect a hands-off state on the basis of at least the captured steering variable and to output it as output data. The output data are combined in weighted form to form a hands-off state and are provided. The values of the weightings are determined on the basis of a current context. There is also described an apparatus for detecting a hands-off state at a steering wheel, a steering system for a vehicle, and a vehicle with the apparatus for detecting the hands-off state.

### CROSS-REFERENCE TO RELATED APPLICATION

This application claims the priority, under 35 U.S.C. § 119, of German Patent Application DE 10 2023 211 071.7, filed Nov. 8, 2023; the prior application is herewith incorporated by reference in its entirety.

### FIELD AND BACKGROUND OF THE INVENTION

The invention relates to a method and an apparatus for detecting a hands-off state at a steering wheel. The invention also pertains to a corresponding steering system and to a vehicle with a hands-off detection apparatus.

In vehicles, sensors, for example a capacitive steering wheel, are used to monitor driver activity. Such a steering wheel detects when the steering wheel is touched or is not touched (“hands-off”) by the driver by way of a capacitive sensor. A result is transmitted to pertinent functions, for example a longitudinal and/or lateral guidance assistance system. Driver activity and an attentiveness of the driver can be inferred from the hands touching the steering wheel. For example, provision may be made for the driver to be advised to place their hands on the steering wheel as soon as it is detected that their hands were not on the steering wheel for a predefined time during lateral guidance.

In order to save additional costs of a capacitive sensor in the steering wheel, it is known practice to monitor the driver activity with the aid of artificial neural networks on the basis of a torque (manual torque) captured at the steering wheel. Such a method is known, for example, from DE 10 2019 211 016 A1 and its counterpart US Patent No. U.S. Pat. No. 11,912,283 B2.

### SUMMARY OF THE INVENTION

The invention is based on the object of improving a method and an apparatus for detecting a hands-off state at a steering wheel.

With the above and other objects in view there is provided, in accordance with the invention, a method for detecting a hands-off state at a steering wheel. The method comprises the following method steps:
capturing a steering variable at the steering wheel;
supplying the steering variable as input data to at least two trained machine learning models, wherein the machine learning models are trained to detect a hands-off state on a basis of at least the captured steering variable and to output corresponding output data;
determining weighting values on a basis of a current context; and
combining the output data in weighted form to form and provide a hands-off state.

In other words, there is disclosed a method for detecting a hands-off state at a steering wheel, wherein a steering variable is captured at the steering wheel, wherein the captured steering variable is supplied as input data to at least two trained machine learning models, wherein the machine learning models are trained to detect a hands-off state on the basis of at least the captured steering variable and to output it as output data, wherein the output data are combined in weighted form to form a hands-off state and are provided, and wherein values of the weightings are determined on the basis of a current context.

An apparatus for detecting a hands-off state at a steering wheel is also provided in particular, comprising a steering variable sensor configured to capture a steering variable at the steering wheel, a control device, wherein the control device is configured to receive the captured steering variable, to provide at least two trained machine learning models, wherein the machine learning models are trained to detect a hands-off state on the basis of at least the captured steering variable and to output it as output data, to supply the captured steering variable as input data to the trained machine learning models, to also combine the output data in weighted form to form a hands-off state and to provide them, and to determine values of the weightings on the basis of a current context.

The method and the apparatus make it possible to improve the detection of a hands-off state. In particular, the method and the apparatus allow detection of the hands-off state to be improved in different contexts. For this purpose, provision is made for the captured steering variable to be supplied as input data to at least two trained machine learning models, wherein the machine learning models are trained to detect a hands-off state on the basis of at least the captured steering variable and to output it as output data. In this case, the at least two machine learning models differ from one another, in particular, that is to say they have, in particular, a different structure and/or were trained using different training data. At least some of the machine learning models comprise, in particular, specialized machine learning models (for specific contexts). The output data are combined in weighted form to form a hands-off state and are provided. In this case, the values of the weightings are determined on the basis of a current context. In this case, the weightings are newly defined, in particular, for each time step. A current context is therefore captured and/or detected and the weightings are determined on the basis of the captured and/or detected current context, in particular during use.

One advantage of the method and the apparatus is, in particular, that a hands-off state can be detected in an improved manner since a plurality of different domains or an overall larger domain can be covered by using a plurality of machine learning models. Furthermore, individual or multiple ones of the at least two machine learning models may be specialized for specific contexts, thus improving robustness and/or quality when detecting the hands-off state.

A steering variable is, in particular, a variable which represents and/or describes a current state of the steering wheel. A steering variable is, in particular, a torque that is captured, in particular, by means of a torque sensor at the steering wheel. In principle, however, a steering variable may also be another variable that is captured directly or indirectly at the steering wheel. For example, provision may be made to capture a current at an electrical machine at the steering wheel and to use it as the steering variable. The hands-off state can be detected solely on the basis of the steering variable captured at the steering wheel, in particular a captured torque. However, it is also possible, in particular, for further (steering) variables, which are captured at the steering wheel (for example a steering wheel angle and/or a steering wheel angular velocity etc.), to be supplied to the machine learning models and for the trained machine learning models to detect the hands-off state also taking into account this/these further variable(s). In addition, it is also possible to take into account variables which are not captured at the steering wheel, for example a vehicle speed, a lateral acceleration, a yaw rate, wheel ticks, absorber information and/or other driving dynamics variables etc. In particular, however, a capacitively operating sensor is not provided at the steering wheel.

A hands-off state is, in particular, a state in which the steering wheel is not touched by the driver. In particular, none of the driver's fingers is in contact with the steering wheel. The detection of the hands-off state may comprise, in particular, providing a hands-off state signal. This signal comprises, for example, a hands-off probability or coded signals for the “hands-off detected” and “hands-off not detected” states.

A context denotes or comprises, in particular, properties of a situation in which the hands-off state is intended to be detected. Examples of properties which can determine a context are: an external temperature, an internal temperature, a steering wheel vibration, a load and/or a weight of the vehicle, the presence of a trailer, properties (for example identity, sex, age, weight) of the driver etc. The current context is detected and/or determined, in particular, on the basis of captured sensor data. For example, provision may be made for such sensor data to be retrieved via a CAN bus of a vehicle and/or to be received from sensors and/or a vehicle controller of the vehicle.

A machine learning model is, in particular, in the form of a neural network and comprises, in particular, a plurality of internal layers. The machine learning model is, in particular, an artificial recurrent neural network that processes the input data Xₜ at each time t and outputs a hands-off probability yₜ in [0,1]: yₜ=p(xₜ|x_{0:t-1}). In this case, the neural network has, in particular, a so-called memory h in which information from previous time steps is stored and which can be used for the output in the current time step. The output is processed further by means of filtering, for example, before the accepting functions (for example a lateral guidance assistant) process it. Provision may be made, in particular, for a binary hands-off signal (with the two states “hands-off detected” and “hands-off not detected”) to be provided on the basis of a comparison of the hands-off probability with a predefined threshold value.

During a training phase, the machine learning model is or was trained, in particular, using training data comprising pairs in which data relating to the steering variable, in particular torque data, are each paired with a hands-off state. The data relating to the steering variable, in particular the torque data, are, in particular, time series of the steering variable captured at the steering wheel, in particular time series of torques captured at the steering wheel. The training data are obtained, in particular, with the aid of test drives and/or in simulators. In principle, training data can be provided in this case, in particular, according to the method described in the above-mentioned U.S. Pat. No. 11,912,283 B2 and DE 10 2019 211 016 A1. The training is carried out in a manner that is known per se, in particular by way of supervised learning.

Parts of the apparatus, in particular the control device, may be designed individually or together as a combination of hardware and software, for example as program code which is executed on a microcontroller or microprocessor. However, provision may also be made for parts to be designed individually or together as an application-specific integrated circuit (ASIC) and/or a field-programmable gate array (FPGA).

In particular, provision is made for the results from the at least two machine learning models to be combined in the form of a sum weighted with the weightings. This can be mathematically expressed, in particular, as:

$${HOD}_{t} = \frac{{\sum }_{i} {θ}_{{i}_{t}} * {y}_{{i}_{t}}}{{\sum }_{i} {θ}_{{i}_{t}}}$$

where HODₜ is the combined value for the hands-off state estimated at the time t;θᵢ_{ₜ} is the weighting of the machine learning model i at the time t and yᵢ_{ₜ} is the value respectively estimated by the machine learning models for the hands-off state estimated at the time t (for example a hands-off probability).

In one embodiment, provision is made for the values of the weightings to be constantly changed within a predefined transition time in the event of a context change. As a result, there is a smooth transition of the weightings in the event of a context change, with the result that the respective influence of the machine learning models on a final result does not abruptly change, but rather is constantly adapted from a previous value to the new value within the predefined transition time. This makes it possible to increase detection quality and driving comfort. The predefined transition time may comprise, for example, one or more seconds. Provision may be made for the transition time to be predefined and/or determined taking into account the current context. This makes it possible to flexibly adapt the speed, at which the weightings are changed, to different contexts or situations. This makes it possible to change the weightings more quickly in selected situations (for example in dangerous situations).

In one embodiment, provision is made for one of the at least two trained machine learning models to be a general standard model and for at least one other of the at least two trained machine learning models to be a machine learning model trained for a specific context. This makes it possible to provide a machine learning model for every context. In particular, provision may be made for the general standard model to be given a higher weighting if there is no specialized machine learning model for a current context. The general standard model is, in particular, a machine learning model trained in a multiplicity of possible contexts. This ensures that the hands-off state is detected reliably even if no machine learning model specialized for a current context is available. In other words, the general standard model forms a type of fallback model which is given a higher weighting whenever no specialized machine learning model is available.

In one embodiment, provision is made for at least some of the weightings to be determined on the basis of at least one parameter of the current context by means of an assignment table (which can also be referred to as a look-up table). This makes it possible to determine the weightings without great computational effort. The assignment table comprises, in particular, an assignment of at least one parameter of a context to at least some of the weightings, that is to say a value or value range of the at least one parameter is assigned in the assignment table precisely one combination of weightings that is used for precisely this value or value range.

In one embodiment, provision is made for at least one operating parameter and/or operating parameter range to be assigned to at least one of the at least two machine learning models, wherein the weighting at least of one machine learning model is determined taking into account a distance of the operating parameter and/or operating parameter range from a corresponding parameter of the current context. This makes it possible to take into account an ideal operating range of the machine learning model under consideration. In other words, provision is made for the result of the machine learning model to be given a higher weighting, the closer the current context is for the at least one operating parameter and/or operating parameter range. For example, provision may be made for the machine learning model to have the highest quality at a predefined temperature or within a predefined temperature range, for example in the range above 0° C. or in a range around 20° C. etc. The weighting is then determined, for example, in an inversely proportional manner to a distance from the predefined temperature or the predefined temperature range, wherein the weighting is greatest if the predefined temperature or the predefined temperature range is present. Further examples of operating parameters are: a vehicle speed, a bend radius, a lateral acceleration or other driving dynamics variable.

In one embodiment, provision is made for at least one further machine learning model, which is trained to detect a hands-off state on the basis of at least the captured steering variable and to output it as output data, to be activated in a context-dependent manner and to be taken into account in a weighted manner or deactivated. This also makes it possible to completely deactivate a machine learning model, with the result that an associated result is not taken into account at all. In this case, provision is made, in particular, for deactivation to comprise the deactivated machine learning model not being executed at all or associated computing operations not being executed. This makes it possible to save computing power and storage space.

In one embodiment, provision is made for the weighting of at least one of the machine learning models to be determined on the basis of the current context by means of a trained third machine learning model. This makes it possible to determine or estimate the weightings for every context. The third machine learning model was trained, in particular during a training phase, with the aid of training data consisting of pairs in which at least one parameter of a context is respectively paired with a value for the weighting. If the weightings of a plurality of machine learning models are estimated, the pairs comprising the respective combinations of the weightings. The training can be carried out in a manner known per se, for example by way of supervised learning.

Further features for configuring the apparatus are apparent from the description of configurations of the method. In this case, the advantages of the apparatus are in each case the same as for the configurations of the method.

Furthermore, there is provided a steering system comprising an apparatus according to one of the described embodiments.

Furthermore, there is also provided a vehicle comprising a steering system and/or an apparatus according to one of the above-described embodiments.

Other features which are considered as characteristic for the invention are set forth in the appended claims.

Although the invention is illustrated and described herein as being embodied in a method and an apparatus for detecting a hands-off state at a steering wheel, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a schematic illustration of one embodiment of the apparatus for detecting a hands-off state at a steering wheel according to the invention;

FIG. 2 shows a schematic illustration of an embodiment of the invention;

FIG. 3 shows a schematic illustration of another embodiment of the invention;

FIG. 4 shows a schematic illustration of yet another embodiment of the invention; and

FIG. 5 shows a schematic flowchart for illustrating an embodiment of the method according to the invention.

### DETAILED DESCRIPTION OF THE INVENTION

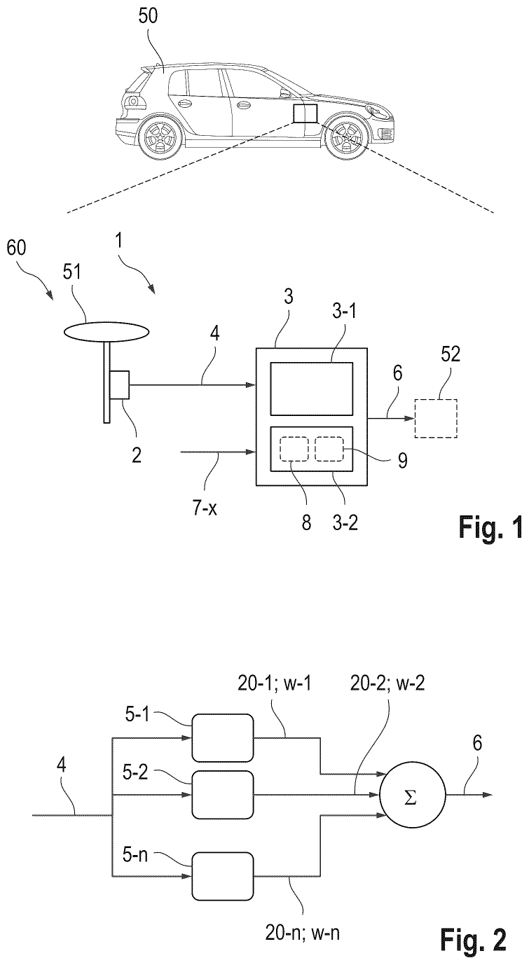

Referring now to the figures of the drawing in detail and first, in particular, to FIG. 1 thereof, there is shown a schematic illustration of one embodiment of the apparatus 1 for detecting a hands-off state 6 at a steering wheel 51. The apparatus 1 is arranged, in particular, in a vehicle 50. The method described in this disclosure is illustrated and explained in more detail below using the apparatus 1.

The apparatus 1 comprises a steering variable sensor 2 and a control device or controller 3. The steering variable sensor 2 is configured to capture a steering variable 4 at the steering wheel 51 of the vehicle 50. The steering variable sensor 2 is, for example, a torque sensor and the steering variable 4 is a torque.

The control device 3 comprises a computing device 3-1 and a memory 3-2. The computing device 3-1 is configured to carry out computing operations needed to carry out measures of the method and for this purpose can access data stored in the memory 3-2.

The control device 3 is configured to receive the captured steering variable 4, to provide at least two trained machine learning models 5-x (cf. FIG. 2), wherein the machine learning models 5-x are trained to detect a hands-off state 6 on the basis of at least the captured steering variable 4 and to output it as output data 20-x, to supply the captured steering variable 4 as input data to the trained machine learning models 5-x, to also combine the output data 20-x in weighted form to form a hands-off state 6 and to provide them, and to determine values of the weightings w-x on the basis of a current context 7-x (cf. FIG. 1).

The hands-off state 6 is supplied, for example as a state signal, to a control unit 52 of the vehicle 50 for further processing. The control unit 52 may be, for example, a lateral guidance assistant or another assistance system. The state signal may be a hands-off probability, for example, or may be a binary state value having the two states “hands-off detected” and “hands-off not detected”.

Provision may be made, for example, for the weightings w-x to be determined on the basis of values of at least one parameter of the captured and/or detected context 7-x. This is carried out, in particular, by means of the control device 3 which determines the weightings w-x, for example, for each context 7-x or for values of the at least one parameter by means of an assignment table 8 which is stored in the memory 3-2 and includes an assignment of contexts 7-x to weightings w-x.

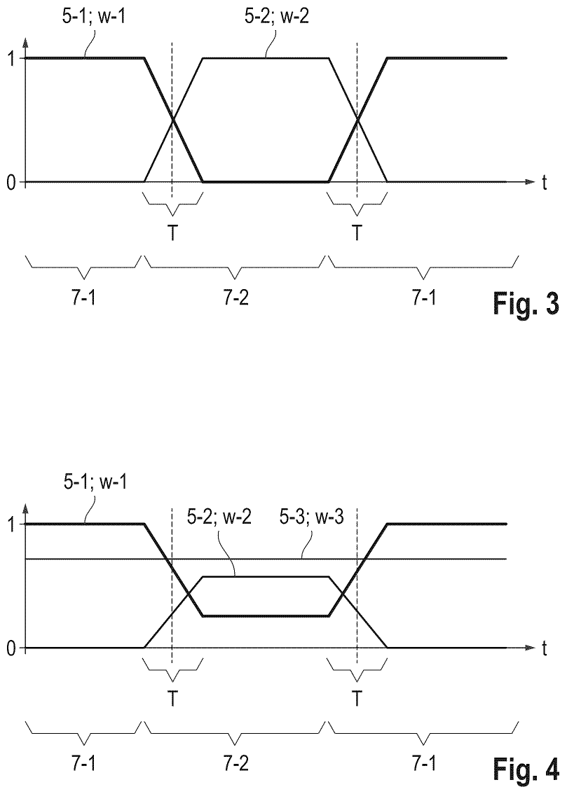

Provision may be made for the values of the weightings w-x to be constantly changed within a predefined transition time T in the event of a context change. This is schematically illustrated in FIG. 3. By way of example, FIG. 3 shows the temporal development of the weightings w-x of two machine learning models 5-x against the time axis t. At the beginning, the context 7-1 is present, for which one machine learning model 5-1 is specialized, for example. The weighting w-1 belonging to this machine learning model 7-1 therefore has the value 1, whereas the weighting w-2 of the other machine learning model 7-2 has the value zero. The context 7-2 is then detected somewhat later, for which the other machine learning model 5-2 is specialized, for example. Therefore, after the context 7-2 has been detected, the weighting w-1 is reduced from the value 1 to the value zero and at the same time the weighting w-2 is increased from the value zero to the value 1 within the predefined transition time T. The context 7-1 is then detected again even later. Accordingly, after the context 7-1 has been detected, the weighting w-2 is reduced from 1 to zero and the weighting w-1 is increased again from zero to 1 within the transition time T. Provision may be made for the transition time T to be predefined and/or determined taking into account the current context 7-x.

FIG. 4 shows a schematic illustration for illustrating the change in the weightings w-x in the case of three machine learning models 5-x. The sum of the weightings w-x is standardized, in particular, to the value 1, as shown in the mathematical formula in the general description. In the example shown, the machine learning model 5-3 is taken into account in both contexts 7-1, 7-2 with a constant value for the weighting w-3.

Provision may be made for one of the at least two trained machine learning models 5-x to be a general standard model and for at least one other of the at least two trained machine learning models to be a machine learning model 5-x trained for a specific context 7-x. With reference to FIG. 3, provision may be made, for example, for the machine learning model 5-1 to be the general standard model. In contrast, the machine learning model 5-2 is specialized for the context 7-2, for example if steering wheel vibrations have been detected at the steering wheel. With reference to FIG. 4, provision may be made, for example, for the machine learning model 5-1 to be the general standard model. In contrast, the machine learning model 5-2 is specialized for the context 7-2, for example if steering wheel vibrations have been detected at the steering wheel. In contrast, the machine learning model 5-3 takes into account a temperature or a temperature influence when detecting the hands-off state 6.

Provision may be made for at least some of the weightings w-x to be determined on the basis of at least one parameter of the current context 7-x by way of an assignment table 8 (FIG. 1). The assignment table 8 is stored, for example, in the memory 3-2 of the controller 3.

Provision may be made for at least one operating parameter and/or operating parameter range to be assigned to at least one of the at least two machine learning models 5-x, wherein the weighting w-x at least of one machine learning model 5-x is determined taking into account a distance of the operating parameter and/or operating parameter range from a corresponding parameter of the current context 7-x. For example, the operating parameter and/or operating parameter range may relate to a temperature or a vehicle speed. The weighting w-x can then be selected, for example, to be inversely proportional to the distance, that is to say the weighting w-x has the value of 1, in particular, when the distance is equal to zero, wherein the value is gradually reduced to zero (or another value), the greater the distance becomes.

Provision may be made for at least one further machine learning model 5-x, which is trained to detect a hands-off state 6 on the basis of at least the captured steering variable 4 and to output it as output data 20-x, to be activated in a context-dependent manner and to be taken into account in a weighted manner or deactivated. Deactivation would mean that no more computing operations are carried out for the deactivated machine learning model 5-x. Provision may also be made for memory areas occupied by the deactivated machine learning model to be released. In particular, provision may be made to use a multiplicity of trained machine learning models 5-x which are activated or deactivated depending on the current context 7-x.

Provision may be made for the weighting w-x of at least one of the machine learning models 5-x to be determined on the basis of the current context 7-x by means of a trained third machine learning model 9. For this purpose, the controller 3 provides the third machine learning model 9. Provision may be made, in particular, for the weightings w-x of all machine learning models 5-x to be determined on the basis of the current context 7-x by means of the trained third machine learning model 9.

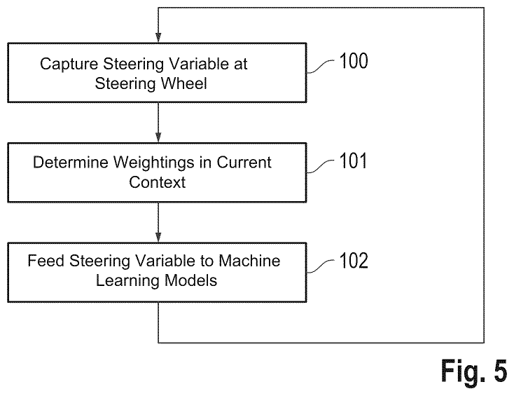

FIG. 5 shows a schematic flowchart for illustrating an exemplary embodiment of the method for detecting a hands-off state at a steering wheel.

In a step 100, a steering variable is captured at a steering wheel by means of a steering variable sensor. The sensor may be a torque sensor and the variable may be a torque.

In a step 102, the captured steering variable is supplied as input data to at least two trained machine learning models, wherein the machine learning models are trained to detect a hands-off state on the basis of at least the captured steering variable and to output it as output data, wherein the output data are combined in weighted form to form a hands-off state and are provided.

In a foregoing (i.e., upstream) step 101, values of the weightings are determined on the basis of a current context.

The steps 100 to 102 are then repeated.

The following is a summary list of reference numerals and the corresponding structure used in the above description of the invention:
1 Apparatus
2 Steering variable sensor
3 Control device
3-1 Computing device
3-2 Memory
4 Steering variable
5-x Machine learning model
6 Hands-off state
7-x Context
8 Assignment table
9 Third machine learning model
20-x Output data
50 Vehicle
51 Steering wheel
52 Control unit
60 Steering system
100-102 Method steps
t Time axis
T Transition time
W-x Weighting

1. A method for detecting a hands-off state at a steering wheel, the method which comprises:
capturing a steering variable at the steering wheel;
supplying the steering variable as input data to at least two trained machine learning models, wherein the machine learning models are trained to detect a hands-off state on a basis of at least the captured steering variable and to output corresponding output data;
determining weighting values on a basis of a current context; and
combining the output data in weighted form to form and provide a hands-off state.

2. The method according to claim 1, which comprises continuously changing the weighting values within a predefined transition time upon a change of the context.

3. The method according to claim 1, wherein one of the at least two trained machine learning models is a general standard model and at least one other of the at least two trained machine learning models is a machine learning model trained for a specific context.

4. The method according to claim 1, which comprises determining at least some of the weighting values on a basis of at least one parameter of the current context by way of an assignment table.

5. The method according to claim 1, wherein at least one operating parameter or operating parameter range is assigned to at least one of the machine learning models, and a weighting of the at least one machine learning model is determined by taking into account a distance of the operating parameter or operating parameter range from a corresponding parameter of the current context.

6. The method according to claim 1, which comprises activating at least one further machine learning model depending on the context, wherein the further machine learning model is trained to detect and output a hands-off state on a basis of at least the captured steering variable, and taking the further machine learning model into account in a weighted manner or deactivating same.

7. The method according to claim 1, which comprises determining the weighting of at least one of the machine learning models based on the current context by a trained third machine learning model.

8. An apparatus for detecting a hands-off state at a steering wheel, the apparatus comprising:
a steering variable sensor configured to capture a steering variable at the steering wheel;
a controller configured to receive the steering variable captured by said sensor, to provide at least two trained machine learning models, wherein the machine learning models are trained to detect a hands-off state based on at least the captured steering variable and to output the hands-off state as output data, to supply the captured steering variable as input data to the trained machine learning models, to also combine the output data in weighted form to form a hands-off state and to provide them, and to determine values of the weightings based on a current context.

9. A steering system, comprising an apparatus according to claim 8.

10. A vehicle, comprising an apparatus according to claim 8.

11. A vehicle, comprising a steering system with an apparatus according to claim 8.
